(19) United States
(12) Patent Application Publication
(10) Pub. No.: US 2013/0197965 A1
(43) Pub. Date: Aug. 1, 2013

(54) RISK ASSESSMENT AND MITIGATION PLANNING, SYSTEMS AND METHODS

(71) Applicants: James S. Leitch, Anderson, SC (US); Dan Smith, Spartanburg, SC (US); Peter Ritch, Jensen Beach, FL (US)

(72) Inventors: James S. Leitch, Anderson, SC (US); Dan Smith, Spartanburg, SC (US); Peter Ritch, Jensen Beach, FL (US)

(21) Appl. No.: 13/643,886

(22) PCT Filed: Apr. 25, 2011
(86) PCT No.: PCT/US11/33738

§ 371 Date: Mar. 20, 2013

Related U.S. Application Data
(60) Provisional application No. 61/327,845, filed on Apr. 26, 2010.

(51) Int. Cl. G06Q 10/06

(52) U.S. Cl. CPC G06Q 10/0635
USPC 705/7.28

(57) ABSTRACT

Risk management systems and methods for plant EPCCOM are described. The system comprises a risk management database for storing risk objects, each object representing a real-world risk mitigation factor. A risk recommendation engine is communicatively coupled to the risk management database and is configured to provide recommendations for mitigating and managing risks as a function of efficacy attributes of the risk objects. The efficacy attributes represent the effectiveness mama of previously implemented and/or simulated risk mitigation strategies. The efficacy attributes are preferably multi-variable dependent and are defined by prioritizing and weighing different objectives.

This application claims the benefit of priority to U.S. provisional application Ser. No. 61/327845, filed on Apr. 26, 2010.

### FIELD OF THE INVENTION

The field of the invention is plant engineering, procurement, construction, commissioning, operations, and maintenance (EPCCOM) risk management.

### BACKGROUND OF THE INVENTION

Large scale plant EPCCOM is fraught with risk. Owners, contractors or other stakeholders, who are engaged in designing, building, and starting up new plants or production facilities, may not have relevant experiences or work processes in place to identify, prioritize, mitigate, plan or manage project risks. Left unaddressed, unmitigated risks will increase the probability of unsuccessfully completing the project on schedule and/or on budget.

Some effort has been put forth to identify and mitigate risk in the past. Examples include:

U.S. Pat. No. 5,574828 to Hayward et al. titled “Expert System for Generating Guideline-Based Information Tools”, filed Apr. 28, 1994, describes a computer-based risk assessment system for identifying risk associated with development of software features.

U.S. Pat. No. 7,051,036 to Rosnow et al. titled “Computer-Implemented System and Method for Project Development”, filed Dec. 3, 2001, discusses project risk assessment in the field of plant construction.

U.S. patent application publication 2005/0010459 titled “Project Pre-Review Estimate Method”, filed Jul. 7, 2004, discusses methods of estimating an influence of a change in a process on a larger project, including based on risk.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference docs not apply.

While the above references provide insight into risk management tools (e.g., applications), they fail to recognize the importance of folding actual plant EPCCOM experiences, or factors, back into risk management activities associated with plant EPCCOM, especially with respect to efficacy of a risk mitigation strategy.

U.S. patent application publication 2005/0114829 to Robin titled “Facilitating the Process of Designing and Developing a Project” describes risk management and mitigation processes for software development. Specifically, Robin describes performing post milestone reviews in order to determine the efficacy of contingency plans and readiness activities in mitigating risks. Once the efficacy of these plans and activities is determined, that knowledge can be used to improve risk mitigation strategies for future projects.

Unfortunately, the processes discussed in Robin are limited to software development and fail to address the unique complexities and challenges present in plant EPPCOM. For example, plant EPPCOM activities can have extremely long life cycles, often lasting more than a decade, and may require numerous technical disciplines. Moreover, whereas in software development risk is many associated with deliverable date, in plant EPPCOM the risk spectrum can extend beyond risk to dates to include safety, jurisdiction related issues, logistics, material or resource allocations, or other construction related issues that extend far beyond the scope of Robin. Thus, the processes in Robin have limited applicability to the problems present in plant EPPCOM.

Robin also fails to disclose determining the efficacy of risk mitigation factors other than contingency plans and readiness activities. As such, Robin fails to provide an adequate solution to addressing the broad spectrum of intermediate factors that can either directly or indirectly affect risk mitigation in plant EPPCOM. Moreover, the processes in Robin do not address the multi-objective nature of plant EPPCOM. For example, Robin does not appreciate that efficacy can be calculated as a function of multiple variables wherein each variable is prioritized and weighed, depending on the critical success factors. In other words, each risk mitigation factor can have numerous efficacy values since there are numerous selections and combinations of weighted variables. Thus, at least for the reasons stated above, various disadvantages remain in the processes disclosed in Robin.

Other references have disclosed mitigating risk as a function of previous experience. See, for example, U.S. Pat. No. 7,577,623; U.S. Pat. No. 7,461,036; and U.S. patent application publications 2010/0191952; 2003/0014287; 2009/0265199; and 2006/0229957. However, these references and other known references suffer from the same deficiencies as Robin.

What yet appears to be appreciated is that desirable aspects of plant EPCCOM risk management would comprise computer-based integrated work processes capable of providing risk mitigation recommendations for various stages of the EPCCOM process based on multi-variable-dependent efficacy values of risk mitigation factors and EPCCOM activities. Efficacy of a risk mitigation factor can represent the outcomes of previous plant construction implementations or even simulations. Further, an efficacy of a risk mitigation factor can be represented as a multi-valued parameter object where each value provides an indication of how the risk mitigation factor relates to various aspects of EPCCOM activities.

Thus, there is still a need for improved plant EPCCOM risk assessment and management systems and methods.

### SUMMARY OF THE INVENTION

The inventive subject matter provides apparatus, systems and methods in which a plant engineering, procurement, construction, commissioning, operations, and maintenance (EPCCOM) risk mitigation system has a risk management database for storing (i) risk objects, each risk object representing a real-world risk mitigation factor, and (ii) plant EPCCOM activity objects, each EPCCOM activity object representing a real-world plant EPCCOM activity. The risk mitigation system also has a risk recommendation engine communicatively coupled to the risk management database and configured to provide a risk mitigation recommendation based on various attributes of the risk objects and EPCCOM activities. Preferably, at least one of the attributes is an efficacy attribute representing an outcome of a previously presented, possibly by implementation or simulation, risk mitigation factor. In this manner, systems and methods are provided in which past real-world risk mitigation experiences can be brought to bear against new plant EPCCOM projects or stages. Contemplated systems and processes can aid various inexperienced stakeholders (e.g., plant owner, contractors, vendors, designers, etc.) in mitigating risks before, during, and/or after EPCCOM of a plant or other type of facility.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of one exemplary embodiment of a risk management system.

FIG. 2 is a schematic of one exemplary embodiment of a work process flow plan.

### DETAILED DESCRIPTION

It should be noted that while the following description is drawn to a computer/server based risk mitigation systems, various alternative configurations are also deemed suitable and may employ various computing devices including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including providing a computer-based infrastructure capable of offering risk mitigation recommendations based efficacy attributes of known risk mitigation factor objects.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The disclosed aspects of the inventive subject matter leverage one or more computing devices to store and analyze risk mitigation factors, and to recommend options to mitigate plant EPCCOM risk. The systems and devices can store data representing integrated methodologies, work processes, proprietary lists of potential risks, risk assessments, likelihood, consequence, severity, priority, risk register, mitigation strategies, action plans, progress measurement metrics and reports, and risk readiness reviews. Collectively the disclosed systems and techniques assist owner(s), EPC contractor(s), supplier(s), vendor(s), licensor(s), or other project members to reduce and/or eliminate the potential impact of unmitigated risks on the timely startup of the owner's new plant or production facilities.

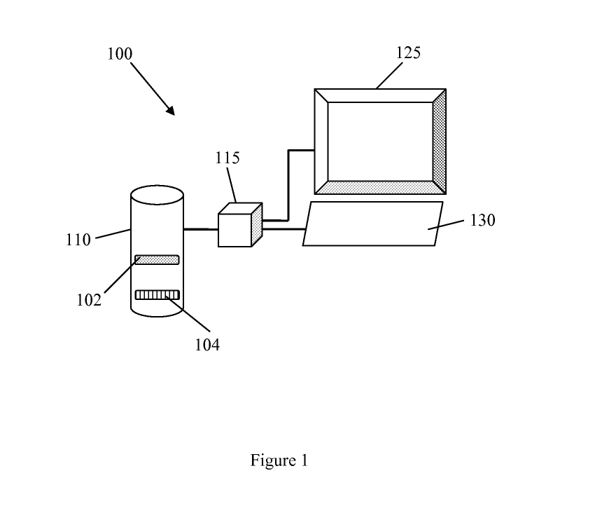

FIG. 1 shows a plant EPCCOM risk mitigation system 100 comprising a risk management database 110 communicatively coupled to a risk recommendation engine 115. Database 110 can be a hard drive on a personal computer or server, flash memory, CD-ROM, or any other device suitable for storing information in digital and/or electronic form. While database 110 is shown as a single device, distributed database configurations are also contemplated embodiments for database 110.

Database 110 has a plurality of risk objects 102 and a plurality of plant EPCCOM activity objects 104 stored therein. Risk objects 102 are digital representations of real-world risk mitigation factors. Examples of risk mitigation factors include: identified risks, performance measures, typical failures, typical causes of failures, performance standards, new faults, risk mitigation templates, reports, risk mitigation controls, risk mitigation plans/procedures, critical success factors, project constraints, individuals, teams, subject matter experts, timelines, or other data items that can be used to represent real-world risk-related factors. The risk mitigation factors can be considered objects employed or engaged with risk mitigation activities. Activity objects 104 are digital representations of real-world plant EPCCOM activities. EPCCOM activities can include: engineering, procurement, construction, commissioning operations, maintenance of the plant or facility, and other related activities. Further example, EPCCOM activities can include selecting resources (e.g., architects, civil engineers, construction managers, sub-contractors, material supply sources, inspectors, equipment, materials, etc.); procuring rights (e.g., land licenses, titles, permits, etc.); planning-stage milestones such as risk identification, identifying subject matter expert identification or steering team meeting, conducting workshops or risk assignments; building construction tasks (e.g., laying foundation, framework, electrical, plumbing, etc.); or other activities related to plant EPCCOM stages.

Risk recommendation engine 115 can comprise a central processing unit (CPU) and executable software code, or any other device and/or combination of devices suitable for analyzing and processing digital data on a database. While engine 115 is shown as a single unit in FIG. 1, distributed engines are also contemplated.

Engine 115 is configured to provide risk recommendations as a function of risk objects 102 and EPCCOM activity objects 104. For example, engine 115 can be configured to analyze, correlate, map, or otherwise process objects 102 and 104 in order to determine a recommendation. Preferably, objects 102 and 104 each have a plurality of object attributes (not shown), and engine 115 performs high-order mapping of objects 102 attributes to activity objects 104 attributes in order to provide risk recommendations. However, all possible combinations of attribute mappings are contemplated, for example, mapping object 102 attributes to other object 102 attributes, or mapping object 104 attributes to other object 104 attributes.

Attributes of objects 102 or 104 can conform to a common namespace allowing engine 115 to easily identifying mappings. Contemplated namespaces can be organized according to one or more schemas as desired. For example, the namespace could be represented by a hierarchy of concepts. Engine 115 can determine if two objects might be related by comparing the attributes names with respect to each other. Thus, engine 115 can determine if a risk mitigation factor can be related to an EPCCOM activity. For further clarity, a specific person might be involved with an activity; welding perhaps. A risk mitigation factor might reference the same person. Engine 115 might then, subject to desired correlation criteria, indicate that the person should be assigned, or not assigned, to the welding activity.

One should note that a risk mitigation factors is not required to correspond to an identified risk or even a risk mitigation action, but can represent items indirectly associated with identified risk or actions. For example, where a risk might represent volatility in a supplier of a resource or material, and indirect risk mitigation factor could include an average lead time when ordering from the supplier.

Examples of risk object attributes can include: likelihood, consequence, severity, priority, equivalents, efficacy values, interdependencies, or other attributes and properties of risk mitigation factors. Examples of EPCCOM activity object attributes can include: order, importance, duration, complexity, reoccurrence, location, or other attributes related to EPCCOM-related activities. It is further contemplated that risk object attributes and EPCCOM activity object attributes could also have attributes (e.g., confidence or relevance values), and can be optionally stored and analyzed as risk objects rather than risk object attributes.

Examples of risk mitigation recommendations can include identifying a new risk, identifying a new fault, identifying a new risk control, identifying a new risk mitigation plan/procedure, identifying a subject matter expert, determining a performance target, providing a project schedule, providing a status report, providing an audit report, revising a previous risk management plan, associating a risk with a team or individual, associating a risk with a discipline, associating a recommendation with a team or individual, ranking or prioritizing risks, mapping a fault to disciplines, mapping a fault to subject matter experts, or any other action, inaction, identification, selection, association, correlation, suggestion, option, approach, plan, or strategy that directly and/or indirectly affects risk mitigation and management. Risk mitigation recommendations are intended to assist stakeholders and project managers in either directly or indirectly addressing possible problems before the problems impact schedules or budgets. Risk mitigation recommendations can also be stored as risk objects for further analysis.

Risk recommendation engine 115 preferably provides recommendations as a function of at least one efficacy attribute of a risk object. For example, a risk object could represent a risk control that has been implemented in previous real-world plant EPCCOM stages and projects, while the efficacy attribute represents the effectiveness of that risk control in achieving certain objectives. Engine 115 would provide a recommendation for a current plant EPCCOM project based on the efficacy attribute of the previously implemented risk control. In this manner, risk mitigation system 100 allows for past experience to be folded back into the system, thus providing a system with “proven” techniques and strategies for mitigating risk.

More importantly for this application, risk recommendation engine 115 preferably provides recommendations as a function of at least one multi-variable dependent efficacy attribute of a risk object. As used herein, “multi-variable dependent efficacy” means efficacy is a function of more than one variable or objective. Since plant EPCCOM projects often involve numerous constraints and competing objectives (e.g. time, cost, space, quality), multi-variable dependent efficacy values allow each risk object to have more than one efficacy attribute, depending on how the variables are selected, prioritized, and/or weighed. Multi-variable dependent efficacy attributes also allows for high-order mappings of efficacy attributes to recommendations, thus providing greater detail, insights, and flexibility for managing risks. In sum, the multi-objective and multi-factor nature of plant EPCCOM is best addressed by providing a system that utilizes multi-variable dependent efficacy attributes of risk mitigation factors.

One should also appreciate that an efficacy attribute can also comprise a multi-value attribute. Within the world of broad spectrum EPCCOM related activities, one should note that efficacy can vary widely from one aspect of plant construction (e.g., engineering) to another aspect (e.g., construction). For example, an engineering activity might represent a high efficacy risk mitigation factor with respect to engineering or design, but the same engineering activity can be considered a low efficacy risk mitigation factor. The inventive subject matter is also considered to include providing a multi-valued efficacy attribute where each member of the attribute reflects an efficacy associated with an EPCCOM activity. Thus, one can considered an efficacy attribute as a vector of values.

Examples members of an efficacy attribute vector can include risk mitigation effectiveness with respect to: costs objectives, time and schedule constraints, quality requirements, space usage, stages of plant life cycle, personnel, logistics, various construction tasks such as welding, or other types of EPCCOM activities.

Multi-variable dependent efficacy attributes can be user-defined by selecting and weighing the competing objectives. User-defined multi-variable dependent efficacy attributes advantageously provides greater flexibility and customization over prior art risk mitigation systems. It is also contemplated that risk recommendation engine 115 can provide recommendations as to how efficacy attributes should be defined. In addition, engine 115 can be configured to recommend which efficacy attributes should be used to provide a future recommendation (i.e., associating efficacy attributes with recommendations). In this manner, risk mitigation system 100 not only incorporates and applies knowledge accumulated from past experiences, but can better analogize and distinguish between past experiences that are more relevant than others to the present project.

An efficacy value can be calculated as desired. In some embodiments, the values can be converted to monetary values where large values might represent low efficacy (i.e., high cost). Efficacy values can also be normalized to allow for a straight forward comparison from one efficacy attribute to another.

Display 125, operating as a risk mitigation interface, is communicatively coupled to engine 115 and is configured to communication a risk mitigation recommendation to a user (e.g., stakeholder or project manager). For example, display 125 can comprise an LCD monitor or a printer. While visual displays are preferred, all devices suitable for communicating with a user, even non-visual displays (e.g., audio speakers) are contemplated. In one embodiment, the risk mitigation recommendation is presented to stakeholders via display 125 on a web page.

Input device 130 is communicatively coupled to risk recommendation engine 115 and is configured to allow a user to interact with engine 115 and database 110. For example, a user can provide additional data (e.g., risk objects, activity objects, object attributes, risk information) and/or instruction (e.g., selecting or rejecting a recommendation, request a report, monitor and track risks objects). In one embodiment, input device 130 is used by a user to accept, validate, and/or rank a recommended risk mitigation procedure. In yet another embodiment, input device 130 is used by a user to rate or grade the effectiveness of a risk mitigation strategy in order to calculate an efficacy value for future recommendations. Input device 130 is preferably a keyboard; however, device 130 could also be a microphone and voice recognition software, a scanner with text recognition software, or any other device suitable for receiving input from a user.

The numerous advantages and applications of the inventive aspects and features of system 100 will become more apparent as plant EPCCOM risk mitigation processes and techniques are further discussed.

Plant EPCCOM risk management processes and techniques can be considered to fall within three main areas:

i Risk Assessments (RA);

ii Risk Mitigation Planning (RMP); and

iii Risk and Readiness Reviews (R+RR)

Desirable aspects of plant EPCCOM risk management systems and techniques would comprise computer-based integrated work processes, lists of potential risks, risk assessments and severity ranking frameworks, progress measurement tracking and reporting, and risk readiness reviews. Contemplated systems can also include database(s) operating as a risk register, or storing one or more mitigation strategies, and prior action plans proven to mitigate risks. Integrated plant EPCCOM risk assessment systems built on a foundation of actual experiences and successful risk mitigation factors enable plant owners, contractors, or other stakeholders to create a successful plant, as opposed to having the stakeholders merely use empty shell applications that fail to provide real-world foundational elements to mitigate risk.

The disclosed systems and techniques can be implemented during the front-end engineering design (FEED) and engineering, procurement and construction (EPC) phases of projects for stakeholders who are engaged in the EPCCOM activities of an owner's new plants, production facilities, or significant plant expansion projects.

The disclosed systems and techniques can include facilitated workshops to identify startup risks, determine consequences and likelihood, rank relative risks, prioritize risks, determine and select risk mitigation strategies, create action plans, prepare the integrated risk mitigation plan, periodically conduct risk readiness reviews, and manage project team members implementation activities providing an integrated and comprehensive risk management methodology. Although a workshop can be held, one should note data from the workshops can be incorporated in a risk management database or a risk recommendation engine.

Various stakeholders (e.g., the plant owner, contractors, subcontractors, suppliers, vendors and licensors) that are involved in the project can engage with the risk management database or risk recommendation engine as desired. The system can identify specific startup risks which are related to a vendor's equipment, a supplier's material, a contractor's design or site work, a service provider's startup work, an owner's preparations, or other related potential sources of startup risks. Furthermore the system engages the affected companies to specifically address the concern or potential risk, and develop corrective action plan(s), set performance measures, and implement the actions necessary to mitigate the risk(s).

One initial step can include performing a Risk Assessment (RA). Subject Matter Experts (SMEs) conduct a steering team meeting to review the goals/objectives, establish the scope, brainstorm the critical success factors and definitions, perform an initial risk analysis, prioritize the risks, organize these by discipline or function, select people to be involved in the analysis and planning efforts, and establish the management guidelines. The collected information can be entered into one or more databases or the risk recommendation engine.

During a subsequent step, the SMEs can conduct an integrated project team workshop with support from the risk recommendation engine. The stakeholders can use the risk recommendation engine to validate the goals/objectives and project scope, to identify and review the critical success factors, to conduct initial risk analysis, or to create a relative risk ranking. The stakeholders can also identify additional risks and consequences, set their relative risk ranking, identify responsibilities, update the risk register (e.g., database), or determine next steps.

SMEs can use the risk recommendation engine to create an organization of the risks into disciplines or critical success factor groups. Recommendations resulting from the analysis conducted by the risk recommendation engine can include mitigation strategies, or create action plan(s) to reduce the likelihood or severity of the risk occurring. The inventive subject matter is considered to include automatically recommending an organization of one or more disciplines or critical success factors based on known mitigation factors as compared to current project activities.

Some risks will be broader, and involve multiple disciplines and/or multiple areas of the project. Recommendations can include a suggested organization of appropriate individuals into a small risk focus teams (RFT). These individuals can use the risk recommendation engine to determine potential startup risks and their causes, determine the risk's relative ranking and priority, establish key performance goals, performance targets, or a measurement process.

It is important to prioritize the risks properly so the team can focus on the most serious issues. For those risks with a high ranking, the team will first focus on developing the mitigation strategies, then preparing the risk mitigation action plans. Lower ranked risks are addressed once high risk mitigation action plans are created. Therefore, contemplated systems can include a recommendation engine capable of providing a recommended relative ranking of risks.

Risk management or performance monitoring processes are set up to enable early identification or prioritization of the more serious issues. Project team members can then quickly place attention or resources where required.

Once the mitigation strategies and action plans are ready, the steering team can meet to review the results of the risk analyses, review recommendations provided by the system, examine the relative risk severity ranking, mitigation strategies, performance tracking/reporting, or the risk mitigation action plans. One should appreciate that such activities can take place in an on-going matter based on analysis of risk data available to the risk recommendation engine. In some embodiments, the risk recommendation engine can provide updated reports or alerts to ensure team members have the most relevant, up-to-date data.

Once the steering team approves any recommendations or plans, the SMEs can use the risk recommendation engine to create the Risk Mitigation Plan (RMP). The RMP integrates the risk mitigation options, identifies their interdependencies, or linkage to the EPC project milestones. The RMP is a resource loaded, precedence based, critical path activity schedule, which defines the integrated risk mitigation plan activities.

SMEs reconvene the steering team workshop to review the RMP, and identify any necessary adjustments. SMEs incorporate any additional information into the risk recommendation engine, then issue the RMP for implementation approval.

SMEs can coordinate the RMP implementation via the contemplated risk mitigation system. Activities include setting up the performance measurement systems, monitoring performance against the critical success factor targets and RMP action plan progress, conduct status meetings, regularly review progress, issue monthly reports, and proactively lead the day-to-day risk mitigation activities. Recognizing projects change over time, the RMP is a living document, and where adjustments are warranted, the SMEs use the risk mitigation system to revise the RMP. One should note that the risk recommendation engine can be used throughout these activities to ensure coherency is maintained or that proper historical risk mitigation factors are incorporated.

The disclosed techniques as applied during the implementation phase include periodically conducting Risk and Readiness Reviews (R+RR). These are done to evaluate the project's progress toward executing the RMP and overall startup readiness, evaluate if new risks have surfaced, create risk mitigation plans as required, conduct a management briefing workshop, and issue a readiness progress report. The R+RR serve as a “fresh eyes” review used to evaluate the status of implementing the RMP, and confirm the risk mitigation action plans are effectively mitigating the risk(s). If new risks are identified, the methodology follows the process described in previous paragraphs above. The “fresh eyes” review provides the owner, EPC contractor(s) and other stakeholders' objective feedback on how effectively the risk mitigation pre-startup activities are being accomplished.

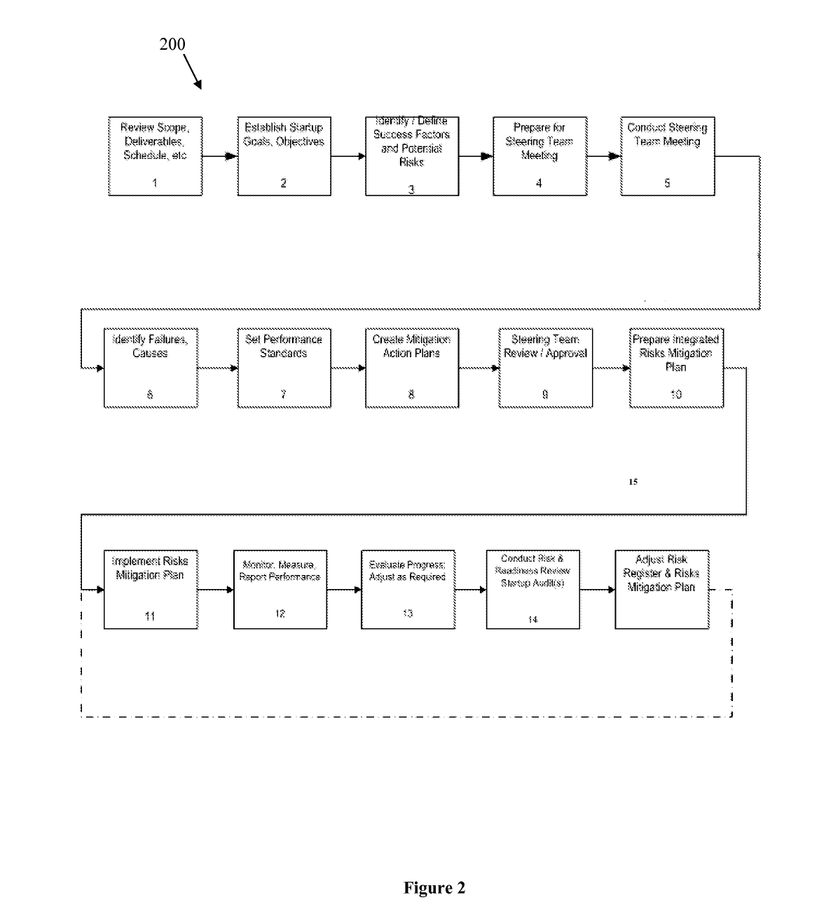

FIG. 2 shows a method 200 of mitigating risk in plant EPCCOM. Method 200 is merely one embodiment for providing a flow of risk data with respect to RA, RMP, and R+RR. Those of skill in the art will appreciate that numerous variations of method 200 can be used consistently with the inventive concepts taught herein. Method 200 presents fifteen different steps and stages for guiding and managing the flow of risk data collection and analysis.

In step one, the project scope, schedule, and deliverables are reviewed. Step one may also include collecting project documents.

Step two requires establishing startup goals and objectives.

In step three, critical success factors are identified and defined. Step three also includes identifying potential risks.

Step four is preparing for a steering team meeting. This can include preparing templates, identifying the steering team members, identifying project leads, and scheduling workshops.

Step five is conducting a steering team meeting. The objectives of the steering team meeting are to validate objectives, brainstorm and define additional critical success factors, brainstorm additional faults and risks, set likelihood, severity and risk guidelines, organize critical success factors by discipline, map faults to disciplines and experts, identify performance measure systems, and identify responsible parties.

Step six involves identifying typical failures and causes of failures. Step six can also include briefing participants, reviewing scope and critical success factors, ranking relative risk levels, determining how to measure faults, and documenting results.

Step seven is setting performance standards. This can include defining critical performance standards, setting performance targets, indentifying how-to measures, identifying measurement sources, leading scorecards, and documenting results.

Step eight is creating mitigation action plans. This can include preparing critical success factors and discipline-specific failure prevention action plans, establishing single point accountability, assigning resources, and documenting results.

In step nine, the steering team reviews and approves the mitigation plans. This step may also include reviewing critical success factors, faults, and causes, reviewing activity schedules, reviewing assignments, reviewing performance measure systems, revising and approving plans, and identifying responsible parties.

Step ten is preparing integrated risk mitigation plans. This can include reviewing discipline failure prevention action plans, identifying interdependencies, preparing resource forecasts, creating integrated schedules, creating performance measurement scorecards, and reviewing joint approvals.

Step eleven is to implement the integrated risk mitigation plans and set up performance measurement systems.

Step twelve is to monitor, measure, and report the performance and implementation of the integrated risk mitigation plans. Step twelve can also include gathering information, assessing status (status vs. actual), updating performance tracking, and creating management status reports.

Steps thirteen is to evaluating progress via conducting status meetings, and provide further guidance, approvals, and adjustments.

Step fourteen is to conduct risk and readiness reviews. Step fourteen can also include auditing progress, determining readiness gaps, identifying possible new faults, generating action plans for new faults, and issuing audit reports.

Step fifteen is to update the risk register (e.g., risk management database) and adjust risk mitigation plans. In light of changes to the risk register and mitigation plans, steps 11-15 may be reiterated as necessary.

All the tasks performed throughout method 200, or any subset of tasks, can be further assisted by computer-based integrated work processes having the inventive features and aspects of system 100. Utilizing system 100 (which uses multi-variable dependent efficacy values) to perform various tasks in method 200 can greatly simplify each step and ensure that all applicable factors are considered. Moreover, system 100 incorporates real-world experience in the form of risk mitigation factor efficacy attributes, which can be brought to bear against current or new plant EPCCOM activities and assist inexperienced stakeholders and project managers in mitigating risks.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A risk mitigation system, the system comprising:
a risk management database storing (i) a plurality of risk objects, each risk object representing a real-world risk mitigation factor, and (ii) a plurality of plant engineering, procurement, construction, commissioning, operations, and maintenance (EPCCOM) activity objects, each EPCCOM activity object representing a real-world EPCCOM activity;
a risk recommendation engine communicatively coupled with the database and configured to provide a risk mitigation recommendation as a function of risk object attributes, including an efficacy attribute, and EPCCOM activity object attributes;
a risk engine interface coupled with the risk recommendation engine through which the risk mitigation recommendation is presented; and
wherein the efficacy attribute represents an outcome of a previously present risk mitigation factor.

2. The system of claim 1, wherein the risk objects include at least one of the following: a risk, performance measure, a typical failure, a cause of failure, a performance standard, a new fault, a control, a procedure, a risk mitigation template, and a critical success factor.

3. The system of claim 1, wherein the risk object attributes include at least one of the following: likelihood, consequence, severity, priority, equivalents, and interdependency.

4. The system of claim 1, wherein the efficacy attribute is a function of at least one of the following: a cost, a time, a quality, and a space.

5. The system of claim 1, wherein the risk mitigation recommendation includes at least one of the following: an identified risk, a mitigation procedure, a control, an assignment of a risk to a person, and a risk ranking.

6. The system of claim 1, wherein the risk mitigation recommendation include at least one of the following: a fault mapping to disciplines, a fault mapping to subject matter experts, a performance target, a project schedule, a status report, an audit report, and a revised risk management plan.

7. The system of claim 1, wherein the efficacy attributes are multi-variable dependent.

8. The system of claim 7, wherein the risk recommendation engine is further configured to provide a recommendation based on a high-order mapping function that correlates the efficacy attributes to plant EPCCOM activity object attributes.

9. The system of claim 1, wherein the recommendation engine is further configured to recommend an individual to be associated with at least one of the risk mitigation recommendations.

10. The system of claim 1, further comprising an input device configured to receive risk object information from a user during plant EPCCOM.

11. The system of claim 10, wherein the risk object information includes at least one of the following types of data: a performance metric, and a project status metric.

12. The system of claim 10, wherein the risk object information is a selection of weighted objectives for determining an efficacy attribute of a risk object.

13. The system of claim 10, wherein the risk object information comprises a user validation.

14. The system of claim 1, further comprising a display device configured to communicate the recommendation to a user.

15. The system of claim 1, wherein the efficacy attribute comprises a multi-valued efficacy attribute.

16. The system of claim 15, wherein the multi-valued efficacy attribute comprises member values where each value reflects an efficacy related to EPCCOM activities.
